(19) United States
(12) Patent Application Publication
(10) Pub. No.: US 2017/0183462 A1
(43) Pub. Date: Jun. 29, 2017

(54) POLY(AMIDE-IMIDE) COPOLYMER FILM, AND DISPLAY DEVICE INCLUDING SAME

(71) Applicants: SAMSUNG ELECTRONICS CO., LTD., Suwon-si (KR); SAMSUNG SDI CO., LTD., Yongin-si (KR)

(72) Inventors: Sun Jin SONG, Seoul (KR); Changae AHN, Suwon-si (KR); A Ra JO, Euiwang-si (KR); Seung Bum Joseph CHUN, Seongnam-si (KR)

(21) Appl. No.: 15/292,654

(22) Filed: Oct. 13, 2016

(30) Foreign Application Priority Data
Dec. 24, 2015 (KR) 10-2015-0186103

(51) Int. Cl. C08J 5/18; C08J 7/04; C09J 7/02; C08G 73/14

(52) U.S. Cl. CPC C08J 5/18; C08G 73/14; C08J 7/04; C09J 7/0282; C08J 2379/08; C09J 2201/606; C09J 2479/086

(57) ABSTRACT

A poly(amide-imide) copolymer film having a compressive modulus of greater than or equal to about 1.8 gigaPascals and a yellowness index of less than or equal to about 3, when measured according to an ASTM E313 standard.

### CROSS-REFERENCE TO RELATED APPLICATION

This application claims priority to Korean Patent Application No. 10-2015-0186103 filed in the Korean Intellectual Property Office on Dec. 24, 2015, and all the benefits accruing therefrom under 35 U.S.C. §119, the content of which is incorporated herein in its entirety by reference.

### BACKGROUND

1. Field

This disclosure relates to a poly(amide-imide) copolymer film and a display device including the poly(amide-amide) copolymer film.

2. Description of the Related Art

Portable display devices such as a smart phone or a tablet PC have been an object of active research because of their high performance and popularity thereof. For example, light-weight flexible (i.e., bendable or foldable) portable display devices have been studied and commercially developed. The portable display device of a liquid crystal display or the like includes a protective window for protecting a display module such as a liquid crystal layer. Currently, most portable display devices have a window including a rigid glass substrate. However, since glass is fragile, when applied to a potable display device or the like, it can be easily cracked or broken by an exterior impact. In addition, glass is rigid, so it may not be applied in a flexible display device. Therefore, attempts have been made to substitute a protective window with a plastic film in a display device. However, it is very difficult to simultaneously satisfy good the mechanical properties (such as hardness) and optical properties of the plastic film, which are required for the protective window in a display device. Accordingly, development of the plastic film material as a protective window for a display device has been delayed.

### SUMMARY

An embodiment provides a poly(amide-imide) copolymer film having great optical properties and mechanical characteristics.

Another embodiment provides a display device including the poly(amide-imide) copolymer film.

An embodiment provides a poly(amide-imide) copolymer film having a compressive modulus of greater than or equal to about 1.8 gigaPascals and a yellowness index of less than or equal to about 3, when measured according to an ASTM E313 standard.

The poly(amide-imide) copolymer film may have a thickness of about 25 micrometers to about 100 micrometers.

The poly(amide-imide) copolymer film may have a tensile modulus of greater than or equal to about 5.3 gigaPascals, when measured according to an ASTM D882 standard.

The poly(amide-imide) copolymer film may have a pencil hardness of greater than or equal to about 3H on a glass substrate with a vertical load of 0.5 kilograms, when measured according to an ASTM D3363 standard.

The poly(amide-imide) copolymer film may have a yellowness index change value of less than or equal to about 0.7 after ultraviolet irradiation for 72 hours.

The poly(amide-imide) copolymer may include a structural unit represented by Chemical Formula 1 and a structural unit represented by Chemical Formula 2:

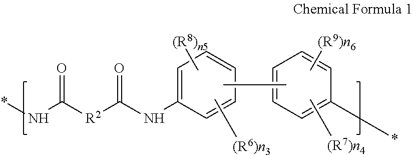

In Chemical Formula 1,

R² is a substituted or unsubstituted phenylene group,

R⁶ and R⁷ are the same or different and are each independently an electron withdrawing group,

R⁸ and R⁹ are the same or different and are each independently a halogen, a hydroxy group, an alkoxy group (—OR²⁰⁴, wherein R²⁰⁴ is a C1 to C10 aliphatic organic group), a silyl group (—SiR²⁰⁵R²⁰⁶R²⁰⁷, wherein R²⁰⁵, R²⁰⁶, and R²⁰⁷ are the same or different and are each independently hydrogen or a C1 to C10 aliphatic organic group), a substituted or unsubstituted C1 to C10 aliphatic organic group, or a C6 to C20 aromatic organic group,

n3 is an integer ranging from 1 to 4, n5 is an integer ranging from 0 to 3, provided that n3+n5 is an integer of 4 or less,

n4 is an integer ranging from 1 to 4, n6 is an integer ranging from 0 to 3, provided that n4+n6 is an integer of 4 or less.

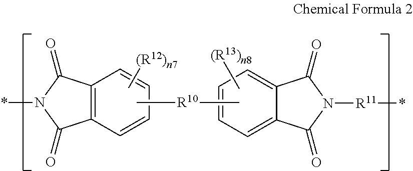

In Chemical Formula 2,

R¹⁰ is a single bond, a substituted or unsubstituted C1 to C30 aliphatic organic group, a substituted or unsubstituted C3 to C30 alicyclic organic group, a substituted or unsubstituted C6 to C30 aromatic organic group, or a substituted or unsubstituted C2 to C30 heterocyclic group,

R¹¹ includes a substituted or unsubstituted C4 to C20 aliphatic cyclic group or a substituted or unsubstituted C6 to C30 aromatic organic group, wherein the aromatic organic group is present as a single ring; a condensed ring system including two or more fused rings; or two or more aromatic rings linked by a single bond, a fluorenylene group, a substituted or unsubstituted C1 to C10 cycloalkylene group, a substituted or unsubstituted C6 to C15 arylene group, —O—, —S—, —C(═O)—, —CH(OH)—, —S(═O)₂—, —Si(CH₃)₂—, —(CH₂)ₚ— (wherein, 1≦p≦10), —(CF₂)_{q}— (wherein, 1≦q≦10), —C(CH₃)₂—, —C(CF₃)₂—, —C(═O)NH—, or a combination thereof,

R¹² and R¹³ are the same or different and are each independently a halogen, a hydroxy group, an alkoxy group (—OR²⁰⁸, wherein R²⁰⁸ is a C1 to C10 aliphatic organic group), a silyl group (—SiR²⁰⁹R²¹⁰R²¹¹, wherein R²⁰⁹, R²¹⁰ and R²¹¹ are the same or different and are each independently hydrogen or a C1 to C10 aliphatic organic group), a substituted or unsubstituted C1 to C10 aliphatic organic group, or a C6 to C20 aromatic organic group, and

n7 and n8 are each independently an integer ranging from 0 to 3.

The R¹¹ of Chemical Formula 2 may be represented by Chemical Formula 3:

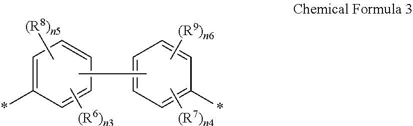

In Chemical Formula 3,

R⁶ to R⁹ and n3 and n4 are the same as defined in Chemical Formula 1.

The R⁶ and R⁷ may independently be an electron withdrawing group selected from —CF₃, —CCl₃, —CBr₃, —Cl₃, —NO₂, —CN, —COCH₃, and —CO₂C₂H₅.

The poly(amide-imide) copolymer may include greater than or equal to 50 mole percent of the structural unit represented by Chemical Formula 1 based on a total number of moles of the structural unit represented by Chemical Formula 1 and the structural unit represented by Chemical Formula 2.

The structural unit represented by Chemical Formula 2 may include a structural unit represented by Chemical Formula 4 and a structural unit represented by Chemical Formula 5:

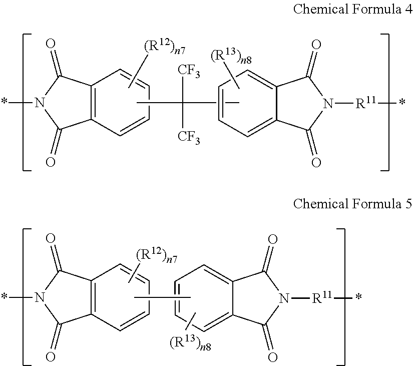

In Chemical Formulae 4 and 5,

R¹¹ to R¹³, n7, and n8 are the same as defined in Chemical Formula 2.

A mole ratio of the structural unit represented by Chemical Formula 4 and the structural unit represented by Chemical Formula 5 may be about 1:99 to about 99:1.

The structural unit represented by Chemical Formula 1 may be represented by Chemical Formula 6, Chemical Formula 7, or a combination thereof:

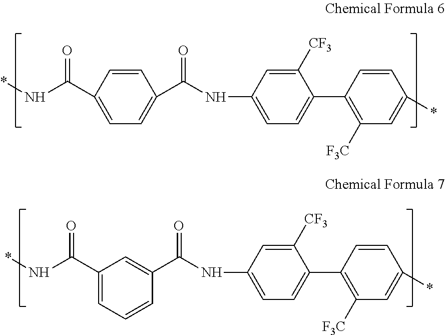

The structural unit represented by Chemical Formula 2 may be a combination of a structural unit represented by Chemical Formula 8 and a structural unit represented by Chemical Formula 9:

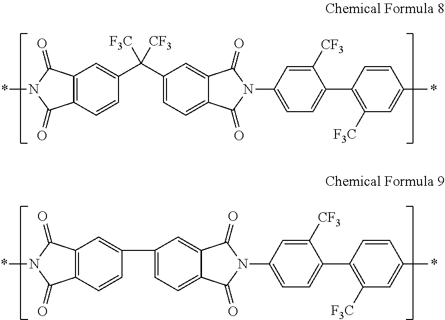

The structural unit represented by Chemical Formula 1 may be represented by Chemical Formula 6, and the structural unit represented by Chemical Formula 2 may be represented by a combination of a structural unit represented by Chemical Formula 8 and a structural unit represented by Chemical Formula 9.

A hard coating layer may be disposed on at least one side of the poly(amide-imide) copolymer film.

The hard coating layer may include an acrylate polymer, a polycaprolactone, a urethane-acrylate copolymer, a polyrotaxane, an epoxy polymer, an organosilicone material, an inorganic hard coating material, or a combination thereof.

A pressure sensitive adhesive layer may be disposed on at least one side of the poly(amide-imide) film.

Another embodiment provides a display device including the poly(amide-imide) copolymer film.

The poly(amide-imide) copolymer film may be a window of the display device.

The display device may be a flexible display device.

### DETAILED DESCRIPTION

This disclosure will be described more fully hereinafter, in which embodiments are shown. This disclosure may, however, be embodied in many different forms and is not to be construed as limited to the exemplary embodiments set forth herein.

Accordingly, the embodiments are merely described below, by referring to the figures, to explain aspects of the present description. As used herein, the term “and/or” includes any and all combinations of one or more of the associated listed items. The term “or” means “and/or.” Expressions such as “at least one of” when preceding a list of elements, modify the entire list of elements and do not modify the individual elements of the list.

It will be understood that when an element is referred to as being “on” another element, it may be directly on the other element or intervening elements may be present therebetween. In contrast, when an element is referred to as being “directly on” another element, there are no intervening elements present.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer, or section. Thus, a first element, component, region, layer, or section discussed below could be termed a second element, component, region, layer, or section without departing from the teachings of the present embodiments.

The terminology used herein is for the purpose of describing particular embodiments only and is not intended to be limiting. As used herein, the singular forms “a,” “an” and “the” are intended to include the plural forms as well, unless the context clearly indicates otherwise. The term “or” means “and/or.” As used herein, the term “and/or” includes any and all combinations of one or more of the associated listed items. Expressions such as “at least one of,” when preceding a list of elements, modify the entire list of elements and do not modify the individual elements of the list.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system).

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

“Mixture” as used herein is inclusive of all types of combinations, including blends, alloys, solutions, and the like.

As used herein, when a specific definition is not otherwise provided, the term “substituted” refers to a functional group substituted with at least one substituent selected from a halogen atom (F, Br, Cl, or I), a hydroxy group, a nitro group, a cyano group, an amino group (—NH₂, —NH(R¹⁰⁰) or —N(R¹⁰¹)(R¹⁰²), wherein R¹⁰⁰, R¹⁰¹, and R¹⁰² are the same or different, and are each independently a C1 to C10 alkyl group), an amidino group, a hydrazine group, a hydrazone group, a carboxyl group, an ester group, a ketone group, a substituted or unsubstituted alkyl group, a substituted or unsubstituted alicyclic organic group, a substituted or unsubstituted aryl group, a substituted or unsubstituted alkenyl group, a substituted or unsubstituted alkynyl group, a substituted or unsubstituted heteroaryl group, and a substituted or unsubstituted heterocyclic group in place of at least one hydrogen, or the substituents may be linked to each other to form a ring.

As used herein, when specific definition is not otherwise provided, the term “alkyl group” refers to a C1 to C30 alkyl group, for example, a C1 to C15 alkyl group; the term “cycloalkyl group” refers to a C3 to C30 cycloalkyl group, for example, a C3 to C18 cycloalkyl group; the term “alkoxy group” refers to a C1 to C30 alkoxy group, for example, a C1 to C18 alkoxy group; the term “ester group” refers to a C2 to C30 ester group, for example, a C2 to C18 ester group; the term “acyl group” refers to a C2 to C30 acyl group, for example, a C2 to C18 acyl group; the term “aryl group” refers to a C6 to C30 aryl group, for example, a C6 to C18 aryl group; the term “alkenyl group” refers to a C2 to C30 alkenyl group, for example, a C2 to C18 alkenyl group; the term “alkynyl group” refers to a C2 to C30 alkynyl group, for example, a C2 to C18 alkynyl group; the term “alkylene group” refers to a C1 to C30 alkylene group, for example, a C1 to C18 alkylene group; and the term “arylene group” refers to a C6 to C30 arylene group, for example, a C6 to C16 arylene group.

As used herein, when specific definition is not otherwise provided, the term “aliphatic organic group” refers to a C1 to C30 alkyl group, a C2 to C30 alkenyl group, a C2 to C30 alkynyl group, a C1 to C30 alkylene group, a C2 to C30 alkenylene group, or a C2 to C30 alkynylene group, for example, a C1 to C15 alkyl group, a C2 to C15 alkenyl group, a C2 to C15 alkynyl group, a C1 to C15 alkylene group, a C2 to C15 alkenylene group, or a C2 to C15 alkynylene group; the term “alicyclic organic group” refers to a C3 to C30 cycloalkyl group, a C3 to C30 cycloalkenyl group, a C3 to C30 cycloalkynyl group, a C3 to C30 cycloalkylene group, a C3 to C30 cycloalkenylene group, or a C3 to C30 cycloalkynylene group, for example, a C3 to C15 cycloalkyl group, a C3 to C15 cycloalkenyl group, a C3 to C15 cycloalkynyl group, a C3 to C15 cycloalkylene group, a C3 to C15 cycloalkenylene group, or a C3 to C15 cycloalkynylene group; the term “aromatic organic group” refers to a single aromatic ring, a condensed ring system including two or more aromatic rings, or two or more aromatic rings linked by a single bond, a fluorenylene group, —O—, —S—, C—(═O)—, —CH(OH)—, —S(═O)₂—, —Si(CH₃)₂—, —(CH₂)ₚ— (wherein, 1≦p≦10), —(CF₂)_{q}— (wherein, 1≦q≦10), —C(CH₃)₂—, —C(CF₃)₂—, —C(═O)NH—, or a combination thereof, for example, —S(═O)₂—, a C6 to C30 group, or a combination thereof, for example, a C6 to C30 aryl group or a C6 to C30 arylene group, for example, a C6 to C16 aryl group or a C6 to C16 arylene group such as phenylene group; the term “heterocyclic group” refers to a C2 to C30 cycloalkyl group, a C2 to C30 cycloalkylene group, a C2 to C30 cycloalkenyl group, a C2 to C30 cycloalkenylene group, a C2 to C30 cycloalkynyl group, a C2 to C30 cycloalkynylene group, a C2 to C30 heteroaryl group, or a C2 to C30 heteroarylene group including 1 to 3 heteroatoms selected from O, S, N, P, Si, and a combination thereof in one ring, for example, a C2 to C15 cycloalkyl group, a C2 to C15 cycloalkylene group, a C2 to C15 cycloalkenyl group, a C2 to C15 cycloalkenylene group, a C2 to C15 cycloalkynyl group, a C2 to C15 cycloalkynylene group, a C2 to C15 heteroaryl group, or a C2 to C15 heteroarylene group including 1 to 3 heteroatoms selected from O, S, N, P, Si, and a combination thereof in one ring.

As used herein, when specific definition is not otherwise provided, the term “alkyl group” refers to a group derived from a straight or branched chain saturated aliphatic hydrocarbon having the specified number of carbon atoms and having a valence of at least one.

As used herein, when specific definition is not otherwise provided, the term “alkoxy group” refers to “alkyl-O”, wherein the term “alkyl” has the same meaning as described above.

As used herein, when specific definition is not otherwise provided, the term “alkenyl group” refers to a straight or branched chain, monovalent hydrocarbon group having at least one carbon-carbon double bond.

As used herein, when specific definition is not otherwise provided, the term “alkynyl group” refers to a straight or branched chain, monovalent hydrocarbon group having at least one carbon-carbon triple bond.

As used herein, when specific definition is not otherwise provided, the term “cycloalkyl group” refers to a monovalent group having one or more saturated rings in which all ring members are carbon.

As used herein, when specific definition is not otherwise provided, the term “cycloalkenyl group” refers to a monovalent group having one or more rings and one or more carbon-carbon double bond in the ring, wherein all ring members are carbon.

As used herein, when specific definition is not otherwise provided, the term “cycloalkynyl group” refers to a monovalent group having one or more rings and one or more carbon-carbon triple bond in the ring, wherein all ring members are carbon.

As used herein, when specific definition is not otherwise provided, the term “acyl group” refers to “alkyl-C(═O)—”, wherein the term “alkyl” has the same meaning as described above.

As used herein, when specific definition is not otherwise provided, the term “aryl group”, which is used alone or in combination, refers to an aromatic hydrocarbon containing at least one ring and having the specified number of carbon atoms. The term “aryl” may be construed as including a group with an aromatic ring fused to at least one cycloalkyl ring.

As used herein, when specific definition is not otherwise provided, the term “heteroaryl group” refers to an aromatic group including carbon and 1 to 3 heteroatoms selected from the group consisting of N, O, S, and P as ring atoms.

As used herein, when specific definition is not otherwise provided, the term “ester group” refers to “alkyl-C(═O)—O—” or “aryl-C(═O)—O—”, wherein the terms “alkyl” and “aryl” have the same meaning as described above.

As used herein, when specific definition is not otherwise provided, the terms “alkylene group”, “alkenylene group”, “alkynylene group”, “cycloalkylene group”, cycloalkenylene group“, cycloalkynylene group”, “arylene group”, and “heteroarylene group” refer to a divalent group respectively derived from an alkyl group, a cycloalkyl group, an aryl group, and a heteroaryl group as defined above.

When a group containing a specified number of carbon atoms is substituted with any of the groups listed in the preceding paragraph, the number of carbon atoms in the resulting “substituted” group is defined as the sum of the carbon atoms contained in the original (unsubstituted) group and the carbon atoms (if any) contained in the substituent. For example, when the term “substituted C1 to C30 alkyl” refers to a C1 to C30 alkyl group substituted with a C6 to C30 aryl group, the total number of carbon atoms in the resulting aryl substituted alkyl group is C7 to C60.

As used herein, when specific definition is not otherwise provided, the term “combination” refers to mixing or copolymerization.

As used herein, the term “polyimide” refers to “polyimide”, “polyamic acid” and a combination thereof. The terms “polyimide” and “polyamic acid” may be used to have the same meanings.

In addition, in the specification, “*” may refer to a point of attachment to nitrogen or any other atom.

Studies on converting a mobile device such as a smart phone or a tablet PC into a lighter, more flexible, and bendable mobile device are currently being conducted. Accordingly, a bendable window film having high hardness for a transparent display capable of replacing a hard glass in most of the mobile devices is highly desired. However, good hardness and optical properties of the film are difficult to simultaneously attain.

Mechanical properties of the film include tensile strength such as Young's modulus, surface pencil hardness, and the like. However, as the thickness of the film is increased, the tensile strength is deteriorated, but scratch resistance is improved. Thus, the tensile strength may not be an adequate parameter to evaluate the hardness of the film. In addition, the pencil hardness may not be appropriate in estimating the film hardness due to low accuracy of a measurement and low experiment reproducibility. On the other hand, since the compressive modulus is a mechanical characteristic with regard to the thickness direction of the film, that is, the vertical direction of the film, a window film having high hardness may have a high compressive modulus, and the compressive modulus has higher accuracy and reproducibility than the pencil hardness. In addition, the window film having a high compressive modulus has high pencil hardness even after hard-coating or pressure sensitive adhesive agent-coating as well as high pencil hardness itself regardless of thickness of the film.

On the other hand, it is desired that the film has a high compressive yield strain, as well as a high compressive modulus, to be recovered from scratch, and further has strong scratch resistance. For example, a film having a compressive yield strain of about greater than or equal to about 2% shows an elastic behavior, and thus, may be completely recovered from scratch when a compressive strain is less than or equal to about 2% due to the scratch. However, when a film having a compressive yield strain of less than or equal to about 2%, the film has insufficient scratch resistance since a scratch is permanently left. However, the compressive yield strain is not easy to experiment with by compressing a thin film until plastic deformation.

A film having a low compressive modulus may not have high hardness after hard coating or pressure sensitive adhesive agent-coating. For example, a film having a compressive modulus of less than or equal to about 1.8 gigaPascals (GPa) may have neither pencil hardness of greater than or equal to 9H after the hard coating nor pencil hardness of greater than or equal to 3H after coating of pressure sensitive adhesive agent. When the thickness of the film is increased, the compressive modulus of the film is also increased, but since a thin film may be desirable for bending or folding characteristics of a module, a very thick film may not be appropriate for this purpose. For example, a film having a thickness of greater than or equal to about 100 micrometers (μm) may hardly be bent up to a bend radius of less than or equal to about 3 millimeters (mm) at an elongational yield strain of greater than or equal to about 1.6%

On the other hand, a window film should have a low yellowness index to realize a transparent display like glass, and yellow color in a film having a yellowness index of greater than or equal to about 3 may be recognized with naked eyes.

Accordingly, the inventors of the present application discovered a window film for a display having a compressive modulus of greater than or equal to about 1.8 GPa and a yellowness index (YI) of less than or equal to about 3, when measured according to an ASTM E313 standard.

Various methods of adjusting the compressive modulus and yellowness index of a film are well known to those who have common knowledge in a related art, but in an exemplary embodiment, a poly(amide-imide) copolymer film may be used to accomplish a poly(amide-imide) copolymer film having the aforementioned compressive modulus and yellowness index.

The film having the aforementioned compressive modulus and yellowness index may maintain the compressive modulus and yellowness index, even when the film has a thickness in a range of about 20 μm to about 100 μm, and shows a high tensile modulus of greater than or equal to about 5.3 GPa. In addition, the film has pencil scratch hardness of greater than or equal to 3H, when measured with a vertical load of about 0.5 kilograms (kg) on a glass substrate according to an ASTM D3363 standard, and when a pressure sensitive adhesive agent (PSA of 8146-50 μm, 3M) is coated on one side of the film, the film has pencil scratch hardness of greater than or equal to H, when measured with a vertical load of about 0.5 kg according to an ASTM D3363 standard. On the other hand, the film having the compressive modulus and the yellowness index shows a low yellowness index change (ΔYI) of less than or equal to about 0.7 before and after ultraviolet (UV) irradiation for 72 hours.

Accordingly, the film having the appropriate compressive modulus and the yellowness index may be used as a high hardness window film and the like for a display device due to strong scratch resistance and high optical characteristics.

On the other hand, polyimide or poly(amide-imide) has excellent mechanical, thermal, and optical properties, and thus, is widely used as a substrate for a display such as an organic light-emitting diode (OLED), a liquid crystal display (LCD), and the like. However, this polyimide or poly(amide-imide) film further requires significantly improved mechanical and optical properties such as significantly high hardness and transmittance and a low yellowness index (YI) so that it may be used as a window film for a flexible display. However, the elastic modulus and YI of the polyimide or poly(amide-imide) film are in a trade-off relationship, and thus, are difficult to simultaneously improve.

The inventors of the present application developed a poly(amide-imide) copolymer film using the poly(amide-imide) copolymer but having a compressive modulus of greater than or equal to a predetermined range rather than a conventional tensile modulus, that is, having a compressive modulus of greater than or equal to about 1.8 GPa and simultaneously, having a yellowness index (YI) of less than or equal to about 3, when measured according to an ASTM E313 standard in an exemplary embodiment. In this embodiment, the film having the compressive modulus and the yellowness index is prepared by using the poly(amide-imide) copolymer film, but the present disclosure is not limited thereto, and various materials may be used to form the film having the desired compressive modulus and the yellowness index.

In an exemplary embodiment, the poly(amide-imide) copolymer film may include a poly(amide-imide) copolymer including a structural unit represented by Chemical Formula 1 and a structural unit represented by Chemical Formula 2:

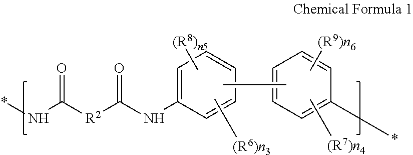

In Chemical Formula 1,

R² is a substituted or unsubstituted phenylene group,

R⁶ and R⁷ are the same or different and are each independently an electron withdrawing group, for example, an electron withdrawing group selected from —CF₃, —CCl₃, —CBr₃, —Cl₃, —NO₂, —CN, —COCH₃, and —CO₂C₂H₅. In an exemplary embodiment, the electron withdrawing group may be —CF₃, but is not limited thereto.

R⁸ and R⁹ are the same or different and are each independently an alkoxy group (—OR²⁰⁴, wherein R²⁰⁴ is a C1 to C10 aliphatic organic group), a silyl group (—SiR²⁰⁵R²⁰⁶R²⁰⁷, wherein R²⁰⁵, R²⁰⁶, and R²⁰⁷ are the same as or different and are each independently hydrogen or a C1 to C10 aliphatic organic group), a substituted or unsubstituted C1 to C10 aliphatic organic group, or a C6 to C20 aromatic organic group,

n3 is an integer ranging from 1 to 4, n5 is an integer ranging from 0 to 3, provided that n3+n5 is an integer of 4 or less, and

n4 is an integer ranging from 1 to 4, n6 is an integer ranging from 0 to 3, provided that n4+n6 is an integer of 4 or less.

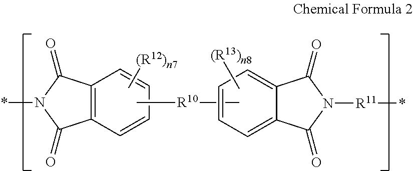

In Chemical Formula 2,

R¹⁰ is a single bond, a substituted or unsubstituted C1 to C30 aliphatic organic group, a substituted or unsubstituted C3 to C30 alicyclic organic group, a substituted or unsubstituted C6 to C30 aromatic organic group, or a substituted or unsubstituted C2 to C30 heterocyclic group,

R¹¹ includes a substituted or unsubstituted C4 to C20 aliphatic cyclic group or a substituted or unsubstituted C6 to C30 aromatic organic group, wherein the aromatic organic group is present as a single ring; a condensed ring system including two or more fused rings; or two or more aromatic rings linked by a single bond, a fluorenylene group, a substituted or unsubstituted C1 to C10 cycloalkylene group, a substituted or unsubstituted C6 to C15 arylene group, —O—, —S—, —C(═O)—, —CH(OH)—, —S(═O)₂—, —Si(CH₃)₂—, —(CH₂)ₚ— (wherein, 1≦p≦10), —(CF₂)_{q}— (wherein, 1≦q≦10), —C(CH₃)₂—, —C(CF₃)₂—, —C(═O)NH—, or a combination thereof,

R¹² and R¹³ are the same or different and are each independently a halogen, a hydroxy group, an alkoxy group (—OR²⁰⁸, wherein R²⁰⁸ is a C1 to C10 aliphatic organic group), a silyl group (—SiR²⁰⁹R²¹⁰R²¹¹, wherein R²⁰⁹, R²¹⁰ and R²¹¹ are the same or different and are each independently hydrogen or a C1 to C10 aliphatic organic group), a substituted or unsubstituted C1 to C10 aliphatic organic group, or a C6 to C20 aromatic organic group, and

n7 and n8 are each independently an integer ranging from 0 to 3.

The R¹⁰ of Chemical Formula 2 may be a single bond or a substituted or unsubstituted C1 to C30 aliphatic organic group, for example, a halogen-substituted C1 to C10 alkylene group.

The R¹¹ of Chemical Formula 2 may be represented by Chemical Formula 3:

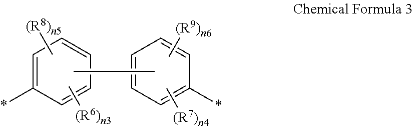

In Chemical Formula 3,

R⁶ to R⁹ and n3 and n4 are the same as defined in Chemical Formula 1.

The poly(amide-imide) copolymer may include greater than or equal to 50 mole percent (mol %) of the structural unit represented by Chemical Formula 1 based on a total number of moles of the structural unit represented by Chemical Formula 1 and the structural unit represented by Chemical Formula 2.

For example, the poly(amide-imide) copolymer may include about 50 mol % to about 80 mol %, for example, about 50 mol % to about 70 mol %, or about 50 mol % to about 60 mol % of the structural unit represented by Chemical Formula 1 based on a total number of moles of the structural unit represented by Chemical Formula 1 and the structural unit represented by Chemical Formula 2.

While not wishing to be bound by theory, it is understood that when the structural unit represented by Chemical Formula 1 is included within the range, a film including the poly(amide-imide) copolymer may have a compressive modulus of greater than or equal to about 1.8 GPa and a yellowness index of less than or equal to about 3, when measured according to an ASTM E313 standard.

The structural unit represented by Chemical Formula 2 may include a structural unit represented by Chemical Formula 4 and a structural unit represented by Chemical Formula 5:

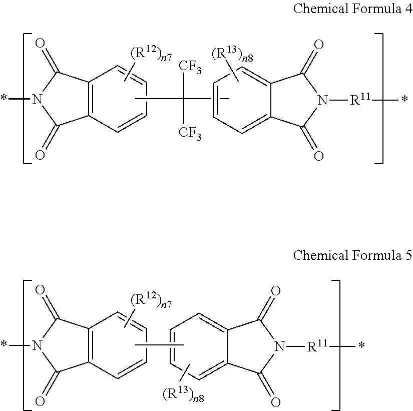

In Chemical Formulae 4 and 5,

R¹¹ to R¹³, n7 and n8 are the same as defined in Chemical Formula 2.

The structural unit represented by Chemical Formula 4 and the structural unit represented by Chemical Formula 5 may be included in a mole ratio of about 1:99 to about 99:1.

For example, the structural unit represented by Chemical Formula 4 and the structural unit represented by Chemical Formula 5 may be included in a mole ratio of about (30 to 70):(70 to 30), wherein “(30 to 70)” refers to the number of moles of the structural unit represented by Chemical Formula 4, and wherein “(70 to 30)” refers to the number of moles of the structural unit represented by Chemical Formula 4. For example, the structural unit represented by Chemical Formula 4 and the structural unit represented by Chemical Formula 5 may be included in a mole ratio of about 50:50.

The structural unit represented by Chemical Formula 1 may be represented by Chemical Formula 6, Chemical Formula 7, or a combination thereof:

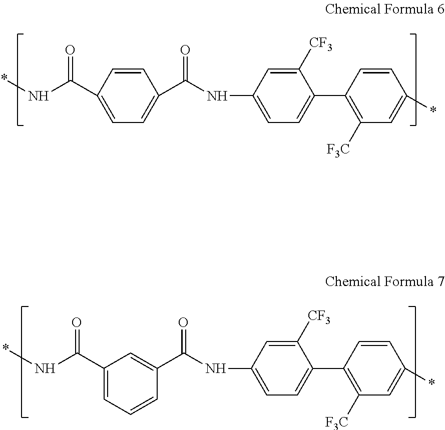

The structural unit represented by Chemical Formula 2 may be a combination of a structural unit represented by Chemical Formula 8 and a structural unit represented by Chemical Formula 9:

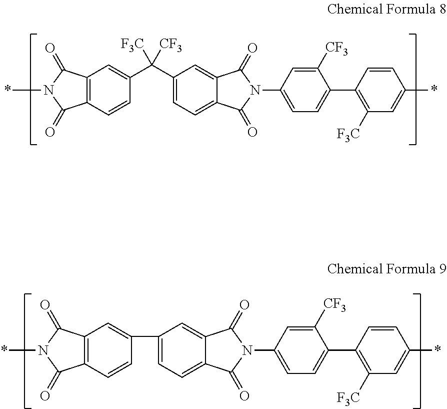

The structural unit represented by Chemical Formula 1 may be represented by Chemical Formula 6, and the structural unit represented by Chemical Formula 2 may be represented by a combination of a structural unit represented by Chemical Formula 8 and a structural unit represented by Chemical Formula 9:

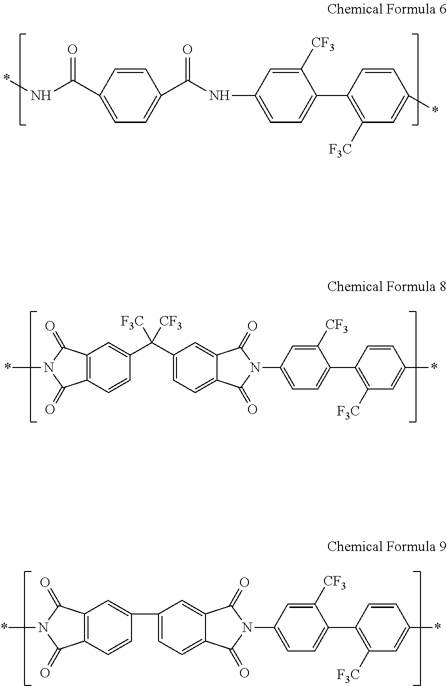

The poly(amide-imide) copolymer film may be obtained to have a desired thickness by using the poly(amide-imide) copolymer. The poly(amide-imide) copolymer may be prepared by a condensation polymerization reaction of a diamine represented by Chemical Formula 10, a dicarboxylic acid derivative represented by Chemical Formula 11, and a dianhydride represented by Chemical Formula 12 in an aprotic polar organic solvent:

NH₂—R¹¹—NH₂ Chemical Formula 10

In Chemical Formula 10,

R¹¹ includes a substituted or unsubstituted C4 to C20 aliphatic cyclic group or a substituted or unsubstituted C6 to C30 aromatic organic group, wherein the aromatic organic group is present as a single ring; a condensed ring system including two or more fused rings; or two or more aromatic rings linked by a single bond, a fluorenylene group, a substituted or unsubstituted C1 to C10 cycloalkylene group, a substituted or unsubstituted C6 to C15 arylene group, —O—, —S—, —C(═O)—, —CH(OH)—, —S(═O)₂—, —Si(CH₃)₂—, —(CH₂)ₚ— (wherein, 1≦p≦10), —(CF₂)_{q}— (wherein, 1≦q≦10), —C(CH₃)₂—, —C(CF₃)₂—, —C(═O)NH—, or a combination thereof.

X—CO—R²—CO—X Chemical Formula 11

In Chemical Formula 12,

R² is a substituted or unsubstituted phenylene group, and

X is Cl, OH, or OCH₃.

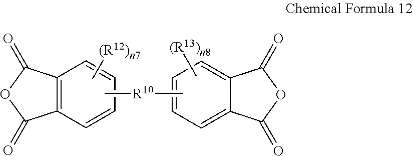

In Chemical Formula 12,

R¹⁰ is a single bond, a substituted or unsubstituted C1 to C30 aliphatic organic group, a substituted or unsubstituted C3 to C30 alicyclic organic group, a substituted or unsubstituted C6 to C30 aromatic organic group, or a substituted or unsubstituted C2 to C30 heterocyclic group,

R¹² and R¹³ are the same or different and are each independently a halogen, a hydroxy group, an alkoxy group (—OR²⁰⁸, wherein R²⁰⁸ is a C1 to C10 aliphatic organic group), a silyl group (—SiR²⁰⁹R²¹⁰R²¹¹, wherein R²⁰⁹, R²¹⁰ and R^{2″} are the same or different and are each independently hydrogen or a C1 to C10 aliphatic organic group), a substituted or unsubstituted C1 to C10 aliphatic organic group, or a C6 to C20 aromatic organic group, and

n7 and n8 are each independently an integer ranging from 0 to 3.

The diamine represented by Chemical Formula 10 may be a diamine represented by Chemical Formula 13:

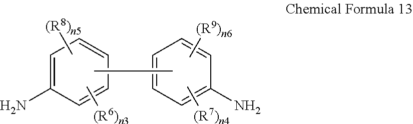

In Chemical Formula 13,

R⁶ and R⁷ are the same or different and are each independently an electron withdrawing group, for example, —CF₃, —CCl₃, —CBr₃, —Cl₃, —NO₂, —CN, —COCH₃, or —CO₂C₂H₅.

The R⁸ and R⁹ are the same or different and are each independently a halogen, a hydroxy group, an alkoxy group (—OR²⁰⁴, wherein R²⁰⁴ is a C1 to C10 aliphatic organic group), a silyl group (—SiR²⁰⁵R²⁰⁶R²⁰⁷, wherein R²⁰⁵, R²⁰⁶ and R²⁰⁷ are the same or different and are each independently hydrogen or a C1 to C10 aliphatic organic group), a substituted or unsubstituted C1 to C10 aliphatic organic group, or a C6 to C20 aromatic organic group,

n3 is an integer ranging from 1 to 4, n5 is an integer ranging from 0 to 3, provided that n3+n5 is an integer of 4 or less,

n4 is an integer ranging from 1 to 4, n6 is an integer ranging from 0 to 3, provided that n4+n6 is an integer of 4 or less.

The compound of Chemical Formula 13 may include a combination of a compound of Chemical Formula 14 and a compound of Chemical Formula 15:

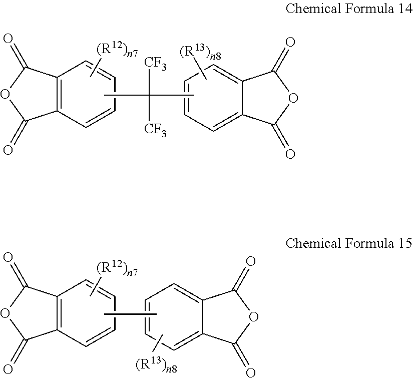

In Chemical Formulae 14 and 15, R¹², R¹³, n7, and n8 are the same as defined above.

The poly(amide-imide) copolymer may be prepared by reacting a diacyl halide compound as a dicarboxylic acid derivative with a diamine in an aprotic polar organic solvent to form an amide structural unit and additionally adding the diamine and the dianhydride thereto to form an amic acid structural unit and simultaneously, connecting the amide structural unit with the amic acid structural unit. The poly(amide-amic acid) copolymer may be a poly(amide-imide) copolymer formed through chemical or thermal imidization.

Alternatively, the poly(amide-imide) copolymer may be prepared by reacting the diamine forming the amide structural unit with a diacyl halide compound to prepare an oligomer including an amide group and having an amino group at both ends thereof (hereinafter, referred to as ‘amide group-containing oligomer’), and reacting this amide group-containing oligomer as a diamine monomer with a dianhydride compound to prepare poly(amide-imide) copolymer. According to this method of preparing the poly(amide-imide) copolymer, a precipitation process for removing a salt of hydrogen halide (HX:X is a halogen) formed as a side product during a process of producing the amide structural unit, which is required in a conventional method of preparing the poly(amide-imide) copolymer, may be omitted. Accordingly, this method may decrease the entire process time and cost and increase a final yield of the prepared poly(amide-imide) copolymer. In addition, the conventional method of preparing the poly(amide-imide) copolymer leads to an increased amount of the amide structural unit out of a predetermined range due to solubility. However, the new method according to the present disclosure has no solubility decrease problem during imidization because the HX salt is not generated, even though the amount of the amide structural unit is increased.

The poly(amide-imide) copolymer according to an embodiment may be prepared according to any method selected from the aforementioned methods without a particular limit.

Examples of the diamine compound may include m-phenylene diamine; p-phenylene diamine; 1,3-bis(4-aminophenyl) propane; 2,2-bis(4-aminophenyl) propane; 4,4′-diamino-diphenyl methane; 1,2-bis(4-aminophenyl) ethane; 1,1-bis(4-aminophenyl) ethane; 2,2′-diamino-diethyl sulfide; bis(4-aminophenyl) sulfide; 2,4′-diamino-diphenyl sulfide; bis(3-aminophenyl) sulfone; bis(4-aminophenyl) sulfone; 4,4′-diamino-dibenzyl sulfoxide; bis(4-aminophenyl) ether; bis(3-aminophenyl) ether; bis(4-aminophenyl)diethyl silane; bis(4-aminophenyl) diphenyl silane; bis(4-aminophenyl) ethyl phosphine oxide; bis(4-aminophenyl) phenyl phosphine oxide; bis(4-aminophenyl)-N-phenyl amine; bis(4-aminophenyl)-N-methylamine; 1,2-diamino-naphthalene, 1,4-diamino-naphthalene; 1,5-diamino-naphthalene, 1,6-diamino-naphthalene, 1,7-diamino-naphthalene; 1,8-diamino-naphthalene, 2,3-diamino-naphthalene; 2,6-diamino-naphthalene; 1,4-diamino-2-methyl-naphthalene, 1,5-diamino-2-methyl-naphthalene; 1,3-diamino-2-phenyl-naphthalene; 4,4′-diamino-biphenyl; 3,3′-diamino-biphenyl; 3,3′-dichloro-4,4′-diamino-biphenyl, 3,3′-dimethyl-4,4′-diamino-biphenyl, 3,3′-dimethyl-4,4′-diamino-biphenyl; 3,3′-dimethoxy-4,4′-diamino-biphenyl; 4,4′-bis(4-aminophenoxy)-biphenyl; 2,4-diamino-toluene; 2,5-diamino-toluene; 2,6-diamino-toluene; 3,5-diamino-toluene; 1,3-diamino-2,5-dichloro-benzene, 1,4-diamino-2,5-dichloro-benzene, 1-methoxy-2,4-diamino-benzene; 1,4-diamino-2-methoxy-5-methyl-benzene, 1,4-diamino-2,3,5,6-tetramethyl-benzene; 1,4-bis(2-methyl-4-amino-pentyl)-benzene 1,4-bis(1,1-dimethyl-5-amino-pentyl)-benzene; 1,4-bis(4-aminophenoxy)-benzene, o-xylylene diamine; m-xylylene diamine; p-xylylene diamine; 3,3′-diamino-benzophenone; 4,4′-diamino-benzophenone; 2,6-diamino-pyridine; 3,5-diamino-pyridine; 1,3-diamino-adamantine; bis[2-(3-aminophenyl)hexafluoroisopropyl]diphenyl ether; 3,3′-diamino-1,1,1′-diadamantane, N-(3-aminophenyl)-4-aminobenzamide; 4-aminophenyl-3-aminobenzoate; 2,2-bis(4-aminophenyl) hexafluoropropane; 2,2-bis(3-aminophenyl) hexafluoropropane; 2-(3-aminophenyl)-2-(4-aminophenyl)hexafluoropropane; 2,2-bis[4-(4-aminophenoxy)phenyl]exafluoropropane; 2,2-bis[4-(2-chloro-4-aminophenoxy)phenyl hexafluoropropane; 1,1-bis(4-aminophenyl)-1-phenyl-2,2,2-trifluoroethane; 1,1-bis[4-(4-aminophenoxy)phenyl]-1-phenyl-2,2,2-trifluoroethane; 1,4-bis(3-aminophenyl) buta-1-ene-3-yne; 1,3-bis(3-aminophenyl) hexafluoropropane; 1,5-bis(3-aminophenyl) decafluoropentane; and 4,4′-bis[2-(4-aminophenoxyphenyl) hexafluoroisopropyl]diphenyl ether, diaminocyclohexane, bicyclohexyldiamine, 4,4′-diaminocyclohexylmethane, diaminofluorene, or a combination thereof. Such diamine compounds may be commercially available or may be obtained by a well-known method.

For example, the diamine compound may be a compound having one or more of the following structures:

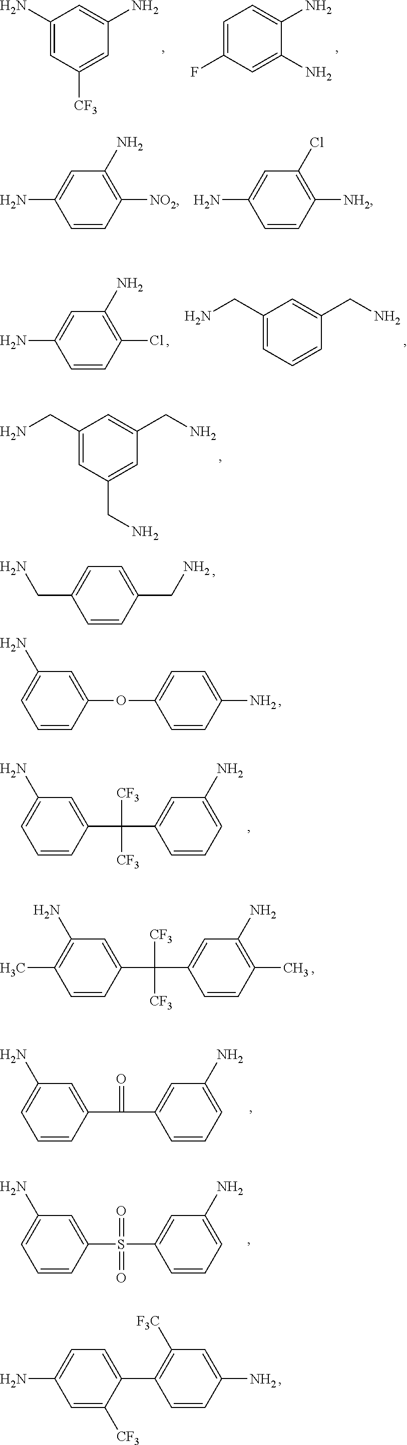

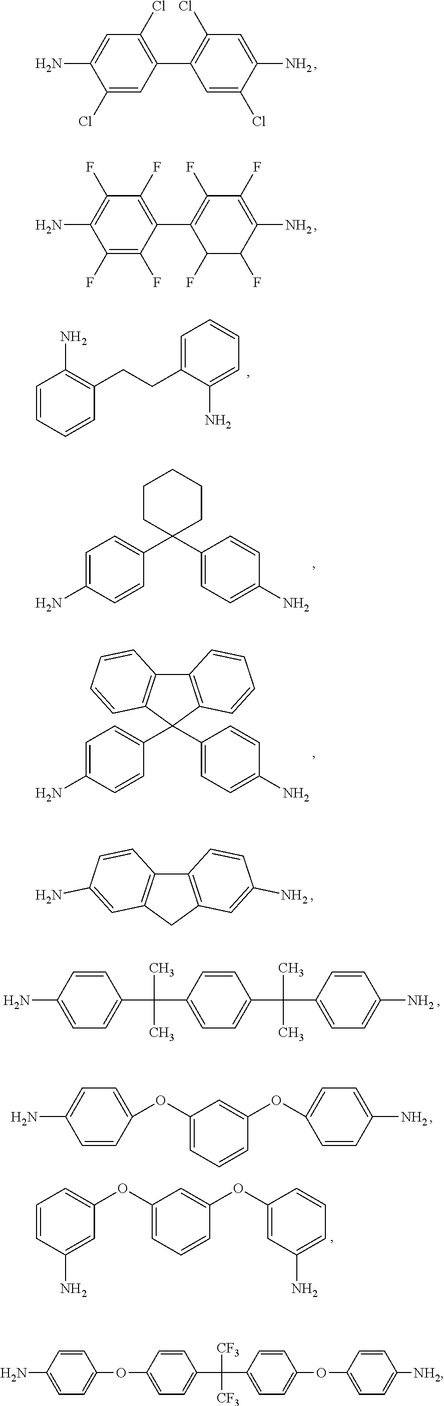

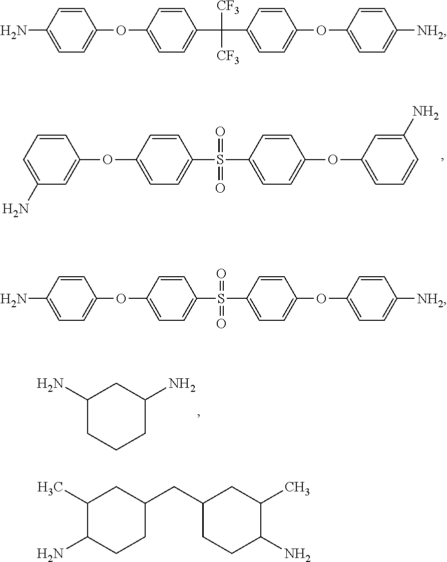 [SMILES: Nc1ccc(Oc2ccc(C(c3ccc(Oc4ccc(N)cc4)cc3)(C(F)(F)F)C(F)(F)F)cc2)cc1 ; Nc1cccc(Oc2ccc(S(=O)(=O)c3ccc(Oc4cccc(N)c4)cc3)cc2)c1 ; Nc1ccc(Oc2ccc(S(=O)(=O)c3ccc(Oc4ccc(N)cc4)cc3)cc2)cc1 ; NC1CCCC(N)C1 ; CC1CC(CC2CCC(N)C(C)C2)CCC1N]

In an exemplary embodiment, the diamine may be 2,2′-bis(trifluoromethyl)benzidine (TFDB).

The dianhydride may be tetracarboxylic dianhydride, and such a compound may be 3,3′,4,4′-biphenyl tetracarboxylic dianhydride (BPDA), bicyclo[2.2.2]oct-7-ene-2,3,5,6-tetracarboxylic dianhydride (BTDA), 3,3′,4,4′-diphenylsulfone tetracarboxylic dianhydride (DSDA), 4,4′-(hexafluoroisopropylidene)diphthalic anhydride (6FDA), 4,4′-oxydiphthalic anhydride (ODPA), pyromellitic dianhydride (PMDA), 4-(2,5-dioxotetrahydrofuran-3-yl)-1,2,3,4-tetrahydronaphthalene-1,2-dicarboxylic anhydride (DTDA), 1,2,4,5-benzene tetracarboxylic dianhydride; 1,2,3,4-benzene tetracarboxylic dianhydride; 1,4-bis(2,3-dicarboxyphenoxy) benzene dianhydride; 1,3-bis(3,4-dicarboxyphenoxy) benzene dianhydride; 1,2,4,5-naphthalene tetracarboxylic dianhydride; 1,2,5,6-naphthalene tetracarboxylic dianhydride; 1,4,5,8-naphthalene tetracarboxylic dianhydride; 2,3,6,7-naphthalene tetracarboxylic dianhydride; 2,6-dichloronaphthalene-1,4,5,8-tetracarboxylic dianhydride; 2,7-dichloronaphthalene-1,4,5,8-tetracarboxylic dianhydride; 2,3,6,7-tetrachloronaphthalene-1,4,5,8-tetracarboxylic dianhydride; 2,2′,3,3′-diphenyl tetracarboxylic dianhydride; 4,4′-bis(3,4-dicarboxyphenoxy)diphenyl dianhydride; bis(2,3-dicarboxylphenyl) ether dianhydride; 4,4′-bis(2,3-dicarboxyphenoxy) diphenyl ether dianhydride; 4,4′-bis(3,4-dicarboxyphenoxy) diphenyl ether dianhydride; bis(3,4-dicarboxylphenyl) sulfide dianhydride; 4,4′-bis(2,3-dicarboxyphenoxy) diphenyl sulfide dianhydride; 4,4′-bis(3,4-dicarboxyphenoxy) diphenyl sulfide dianhydride; bis(3,4-dicarboxylphenyl) sulfone dianhydride; 4,4′-bis(2,3-dicarboxyphenoxy) diphenylsulfone dianhydride; 4,4′-bis(3,4-dicarboxylphenoxy) diphenylsulfone dianhydride; 3,3′,4,4′-benzophenone tetracarboxylic dianhydride; 2,2′,3,3′-benzophenone tetracarboxylic dianhydride; 2,3,3′4′-benzophenone tetracarboxylic dianhydride; 4,4′-bis(3,4-dicarboxylphenoxy) benzophenone dianhydride; bis(2,3-dicarboxylphenyl) methane dianhydride; bis(3,4-dicarboxylphenyl) methane dianhydride; 1,1-bis(2,3-dicarboxylphenyl) ethane dianhydride; 1,1-bis(3,4-dicarboxylphenyl) ethane dianhydride; 1,2-bis(3,4-dicarboxylphenyl) ethane dianhydride; 2,2-bis(2,3-dicarboxylphenyl) propane dianhydride; 2,2-bis(3,4-dicarboxylphenyl) propane dianhydride; 2,2-bis[4-(2,3-dicarboxylphenoxy) phenyl]propane dianhydride; 2,2-bis[4-(3,4-dicarboxylphenoxy) phenyl]propane dianhydride; 4-(2,3-dicarboxylphenoxy)-4′-(3,4-dicarboxylphenoxy) diphenyl-2,2-propane dianhydride; 2,2-bis[4-(3,4-dicarboxylphenoxy-3,5-dimethyl) phenyl]propane dianhydride; 2,3,4,5-thiophene tetracarboxylic dianhydride; 2,3,5,6-pyrazine tetracarboxylic dianhydride; 1,8,9,10-phenanthrene tetracarboxylic dianhydride; 3,4,9,10-perylene tetracarboxylic dianhydride; 1,3-bis(3,4-dicarboxylphenyl) hexafluoropropane dianhydride; 1,1-bis(3,4-dicarboxylphenyl)-1-phenyl-2,2,2-trifluoroethane dianhydride; 2,2-bis[4-(3,4-dicarboxylphenoxy) phenyl]hexafluoropropane dianhydride; 1,1-bis[4-(3,4-dicarboxylphenoxy) phenyl]-1-phenyl-2,2,2-trifluoroethane dianhydride; 4,4′-bis[2-(3,4-dicarboxylphenyl)hexafluoroisopropyl]diphenyl ether dianhydride, or a combination thereof. Such anhydride compounds may be commercially available or may be obtained by a well-known method.

In an exemplary embodiment, the tetracarboxylic acid dianhydride may be 3,3′,4,4′-biphenyl tetracarboxylic dianhydride (BPDA), 4,4′-(hexafluoroisopropylidene) diphthalic anhydride (6FDA), or a combination thereof.

The carboxylic acid derivative may be a carboxylic dihalide, for example, terephthaloyl chloride (TPCl), isophthaloyl chloride (IPCl), 2-fluoro-terephthaloyl chloride, or a combination thereof.

In an exemplary embodiment, the carboxylic dihalide may be terephthaloyl chloride (TPCl).

The amide structure and the imide structure may be formed from the same diamine compound or from a different diamine compound. In other words, the amide structure and the imide structure of the copolymer may be formed from the same or different diamine compounds, which may be at least one diamine selected from the aforementioned diamine compounds.

In an exemplary embodiment, a diamine for forming an amide structure with the carboxylic dihalide may be 2,2′-bis(trifluoromethyl)benzidine (TFDB).

The aprotic polar solvent may be, for example, a sulfoxide solvent such as dimethylsulfoxide, diethylsulfoxide and the like, a formamide solvent such as N,N-dimethylformamide, N,N-diethylformamide, and the like, an acetamide solvent such as N,N-dimethyl acetamide, N,N-diethylacetamide and the like, a pyrrolidone solvent such as N-methyl-2-pyrrolidone, N-vinyl-2-pyrrolidone and the like, a phenol solvent such as phenol, o-, m- or p-cresol, xylenol, halogenated phenol, catechol, and the like, or hexamethylphosphoramide, γ-butyrolactone, and the like. These solvents may be used either alone or in a combination with each other. However, this is not limited thereto, and an aromatic hydrocarbon such as xylene and toluene may also be used.

The poly(amide-imide) copolymer prepared by the above method may be formed into a film by a known method, for example, a dry-wet method, a dry method, or a wet method, but this disclosure is not limited thereto.

The film may be prepared through the dry-wet method, where a layer is formed by extruding a solution including the copolymer from a mouth piece on a support, such as drum or a continuous belt, drying the layer, and evaporating the solvent from the layer until the layer has a self-maintenance property. The drying may be performed for example, at about 25° C. to about 300° C. for about 1 hour or less. When the surface of the drum and the continuous belt used for the drying process becomes flat, a layer with a flat surface is formed. The layer obtained after the drying process is delaminated from the supporter, and input into a wet process, desalted, or desolventized. The final film is prepared by elongating, drying, and heat-treating.

The elongation may range from about 0.8 to about 8, for example, about 1.3 to about 8, in terms of a surface ratio. Herein, the surface ratio is defined as a value obtained by dividing the area of a film after the elongating divided by an area of the film before the elongating. A surface ratio of less than or equal to 1 denotes a relaxed state. Meanwhile, the elongating may be performed not only in a surface direction but also in a thickness direction.

The heat-treating may be performed at a temperature of about 200° C. to about 500° C., for example, at about 250° C. to about 400° C. for about a few seconds to a few minutes.

Also, the film after elongating and heat-treating may be cooled slowly, particularly at a speed of about 50° C./second or lower.

The film may be formed as a single layer or as multiple layers.

The prepared film may have a compressive modulus of greater than or equal to about 1.8 GPa and a yellowness index of less than or equal to about 3 at a thickness of about 20 μm to about 100 μm when measured according to an ASTM E313 standard.

The poly(amide-imide) copolymer film may have a tensile modulus of greater than or equal to about 5.3 GPa, when measured according to an ASTM D882 standard.

The poly(amide-imide) copolymer film may have a pencil hardness of greater than or equal to about 3H on a glass substrate with a vertical load of 0.5 kg, when measured according to an ASTM D3363 standard.

The poly(amide-imide) copolymer film may have a yellowness index change (ΔYI) of less than or equal to about 0.7 after ultraviolet irradiation (UVB) for 72 hours.

A hard coating layer may be disposed on at least one side of the poly(amide-imide) copolymer film. The hard coating layer may have at least one multi-layer structure. The hard coating layer plays a role of increasing surface hardness of a window film. When a glass plate is used as a test plate, the hard coating layer may have hardness of greater than or equal to H, for example, greater than or equal to 8H, when measured with a vertical load of 1 kg according to an ASTM D3363 standard. When such a hard coating layer is included, the poly(amide-imide) copolymer film according to an embodiment may show hardness of greater than or equal to 7H, for example, greater than or equal to 9H. The hard coating layer may be formed by using a material cured by heat or light (that is, a hard coating material). Examples of the material may be an acrylate polymer, a polycaprolactone, a urethane-acrylate copolymer, a polyrotaxane, an epoxy polymer, an organosilicone material, an inorganic hard coating material, and the like, but are not limited thereto. Examples of the multi-functional acrylate monomer may be trimethylolpropane triacrylate (TMPTA), trimethylolpropanethoxy triacrylate (TMPEOTA), glycerine propoxylated triacrylate (GPTA), pentaerythritol tetraacrylate (PETA), and dipentaerythritol hexaacrylate (DPHA), but are not limited thereto

The urethane-acrylate material and multi-functional acrylate material may have improved adherence and high productivity.

In addition, a pressure sensitive adhesive layer may be formed on at least one side of the poly(amide-imide) copolymer film. The poly(amide-imide) film may be disposed on a display module of a display device, and herein, when the film has the pressure sensitive adhesive layer, the film may be fixed on the display module through the pressure sensitive adhesive layer. Accordingly, the poly(amide-imide) copolymer film may be used for a window film of a display device. The display module may be a liquid crystal display module, an organic light-emitting display module, a plasma display module, an electric field effect display module, an electrophoretic display module, and the like, but is not limited thereto.

In another embodiment, a display device including the poly(amide-imide) copolymer film is provided.

The display device may be a flexible display device, and the poly(amide-imide) copolymer film may be a window of the display device.

Hereafter, this disclosure is described in detail with reference to examples. The following examples and comparative examples are not restrictive, but are illustrative.

### Examples

### Synthesis Example 1: Preparation of Amide Group-containing Oligomer

An amide group-containing oligomer bonded with the diamine TFDB (2,2′-bis(trifluoromethyl)benzidine) at both terminal ends and forming an aramid structure according to Reaction Scheme 1 is prepared:

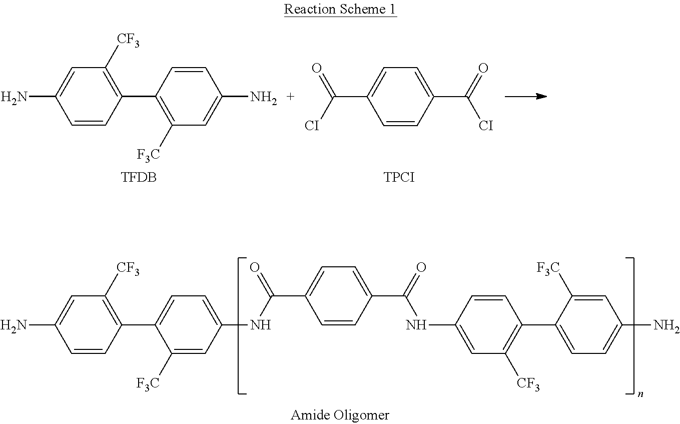

Particularly, 1 mole equivalent (0.107 moles (mol), 34.3 grams, g) of 2,2′-bis(trifluoromethyl)benzidine (TFDB) and 2.8 mole equivalents (0.3 mol, 23.7 g) of pyridine are dissolved in 700 g of N,N-dimethyl acetamide as a solvent in a round-bottomed flask, the remaining TFDB is washed away with 50 milliliters (mL) of DMAC, 15.2 g (0.7 mole equivalents, 0.075 mol) of TPCl (terephthaloic dichloride) is divided into four portions and mixed with the TFDB solution at 25° C., and the mixture is vigorously stirred for 15 minutes.

The resulting solution is stirred under nitrogen atmosphere for 2 hours, added to 7 liters (L) of a NaCl solution containing 350 g of NaCl, and the mixture is stirred for 10 minutes. Then, a solid produced therein is filtered, re-suspended twice in 5 L of deionized water, and re-filtered. Subsequently, a finally filtered product on a filter is thoroughly pressed to remove most of the water remaining and dried at 90° C. under vacuum for 48 hours to obtain an amide group-containing oligomer as a product described in Reaction Scheme 1. The amide group-containing oligomer has a number average molecular weight of about 1,375 Daltons.

### Synthesis Example 2: Preparation of Amide Group-containing Oligomer

An amide group-containing oligomer is prepared according to the same method as described in Synthesis Example 1 by reacting 0.5 mole equivalents of TPCl based on 1 mole equivalent of TFDB. The prepared amide group-containing oligomer has a number average molecular weight of about 801 Daltons.

### Synthesis Example 3: Synthesis of Poly(amide-imide) Copolymer Including 70 mol % of Amide Group

22.96 g (0.0167 mol) of the amide group-containing oligomer according to Synthesis Example 1 is placed in a 250 mL 4-necked double-wall reactor equipped with a mechanical stirrer and a nitrogen inlet and pre-heated at 30° C., and 143 mL of dimethylacetamide (DMAc) is added thereto. The solution is stirred at 30° C. under nitrogen atmosphere until the oligomer is completely dissolved, 3.71 g (0.01 mol) of 6FDA (2,2-bis-(3,4-dicarboxylphenyl)hexafluoropropane dianhydride) and 2.46 g (0.01 mol) of BPDA (3,3′,4,4′-biphenyltetracarboxylic dianhydride) are slowly added to the solution where the oligomer is dissolved. 10 mL of DMAc is further added thereto, the obtained solution is stirred for 48 hours to obtain a poly(amic acid-amide) solution having a solid concentration of 16%.

The temperature of the solution is decreased to 25° C., 5.11 g of anhydrous acetic acid is added to the poly(amic acid-amide) solution, and the mixture is stirred for 30 minutes. 3.96 g of pyridine is added thereto, and the obtained mixture is further stirred for 48 hours to obtain a poly(amide-imide) solution.

### Synthesis Example 4: Synthesis of Poly(amide-imide) Copolymer Including 50 mol % of Amide Group

A poly(amide-imide) copolymer solution including 50 mol % of an amide group is prepared according to the same method as described in Synthesis Example 3 except for using 19.93 g (0.0182 mol) of the amide group-containing oligomer according to Synthesis Example 2, 5.53 g (0.0124 mol) of 6FDA, and 3.66 g (0.0124 mol) of BPDA.

### Synthesis Example 5: Synthesis of Poly(amide-imide) Copolymer Including 50 mol % of Amide Group

A poly(amic acid-imide) copolymer is prepared by reacting 0.2 mole equivalents of TPCl, 0.3 mole equivalents of BPCl, 0.25 mole equivalents of BPDA, and 0.25 mole equivalents of 6FDA based on 1 mole equivalent of TFDB.

Specifically, 145 g of DMAc as a solvent is placed in a 250 L reactor purged with N₂ gas, 14.65 g of TFDB is added thereto at room temperature of 25° C., and the mixture is stirred at 100 revolutions per minute (rpm) for about 30 minutes until the TFDB is dissolved therein. 2.45 g of 20% TPCl and 2.68 g of 30% BPCl based on the content (number of moles) of the TFDB are added thereto, and the mixture is stirred and allowed to react. Subsequently, 3.23 g of 25% BPDA and 4.88 g of 25% 6FDA based on the content (number of moles) of the TFDB are respectively added thereto, and the resulting mixture is stirred at room temperature to prepare a poly(amide-amic acid) copolymer solution. Next, 10 mL of DMAc is further added to the solution, the obtained solution is stirred for 48 hours to obtain a poly(amic acid-amide) solution having a solid concentration of 16%.

The temperature is decreased to 25° C., 6.73 g of anhydrous acetic acid is added to the poly(amide-amic acid) solution, and the mixture is stirred for 30 minutes. 5.21 g of pyridine is added thereto, and the obtained mixture is further stirred for 48 hours to obtain a poly(amide-imide) solution.

### Synthesis Example 6: Synthesis of Polyamic Acid

Polyamic acid is prepared by reacting TFDB, BPDA, and 6FDA as a monomer for preparing polyamic acid in a mole ratio of 100:75:25. Specifically, 143 g of DMAc as a solvent is placed in a 250 L reactor purged with N₂ gas, 13.41 g of TFDB is added thereto at room temperature of 25° C., and the mixture is stirred at 100 rpm for about 30 minutes until the TFDB is dissolved therein. Then, 9.24 g of 75% BPDA and 4.65 g of 25% 6FDA based on the content (number of moles) of the TFDB are respectively added thereto, and the mixture is stirred at room temperature to obtain a polyamic acid polymer. The prepared polyamic acid is stored in a refrigerator.

### Examples 1 to 4 and Comparative Examples 1 to 4: Manufacture of Poly(amide-imide) Copolymer Film and Comparative film and Characteristics Evaluation

The poly(imide-amide) solutions according to Synthesis Examples 3 to 5, the polyamic acid solution according to Synthesis Example 6, a polyethylene terephthalate resin (SR50, SKC), and a polycarbonate resin (S-148, Teijin) solution are respectively coated on a glass plate to cast each film. Each film is dried on an 80° C. hot plate for one hour, heat-treated up to 310° C. at 3 degree Centigrade per minute (° C./min) in an oven, slowly cooled down, and separated from the glass substrate to obtain a final film having a thickness ranging from about 50 to 80 μm.

The compressive modulus, the pencil hardness on the glass substrate and on a pressure sensitive adhesive agent, PSA, the tensile modulus, the yellowness index (YI) of the film, the yellowness index change (ΔYI) before and after ultraviolet (UV) radiation for 72 hours of the film are measured, and the results are provided in Table 1

Herein, the thickness of the film is measured by using Micrometer (Mitutoyo Corp.),

The compressive modulus is measured by using a dynamic mechanical analyzer (DMA) (Model No. Q800, TA Instruments). The DMA having a penetration tip (a diameter=0.035 inch) is used. After stacking a specimen having a width of about 10 millimeters (mm) and a length of about 10 mm to be 1.5±0.05 mm thick, a force constantly increasing up to 18 Newtons (N) at a speed of 18 Newtons per minute (N/min) with the penetration tip having a diameter of 0.035 inches is applied to the specimen at room temperature to obtain a stress-strain curved line. The curved line is used to obtain the compressive modulus in the initial linear section. This initial linear section is defined where a linear trend line has a coefficient of determination (R2) of a maximum or greater than or equal to 0.999.

In Examples and Comparative Examples, the compressive modulus shows high reproducibility with a standard deviation of less than or equal to 0.05 gigaPascals (GPa) when respectively measured five times.

The tensile modulus is respectively measured five times per sample with an ASTM D882 standard after elongating a 10 mm-wide and 50 mm-long film specimen at room temperature at a speed of 0.5 millimeters per millimeter per minute (mm/mm/min) with an Instron 3365 equipment.

The yellowness index (YI) is measured according to an ASTM E313 standard by using a UV spectrophotometer (cm-3600d, Konica Minolta, Inc.).

In addition, the yellowness index change after UV radiating (ΔYI) is obtained as a yellowness index difference (after UV radiating—before UV radiating) through exposure to a UVB wavelength region with an ultraviolet (UV) lamp for 72 hours (greater than or equal to 200 milliJoules per square centimeter, mJ/cm²).

The pencil hardness is measured according to an ASTM D3363 standard with a vertical load of 0.5 kilograms (kg) by using a pencil hardness-measuring instrument and a Mitsubishi pencil. Specifically, after fixing the film on a 2 mm-thick glass plate, the highest hardness without a flaw is obtained as pencil hardness of the film on the glass substrate by measuring hardness five times by every 10 mm with the vertical load of 0.5 kg at a pencil speed of 60 millimeters per minute (mm/min). On the other hand, a pressure sensitive adhesive agent, PSA, instead of the glass substrate is adhered to one side of the film, and pencil hardness on the pressure sensitive adhesive agent (PSA, 3M 8146-50 μm) is measured by the same method as above.

TABLE 1

| | | | | Pencil | Pencil | | | |
|---|---|---|---|---|---|---|---|---|
| | | | Compressive | hardness | hardness | | | Tensile |
| | | Thickness | modulus | on glass | on PSA | | | modulus |
| | Resin | (μm) | (GPa) | (0.5 kg load) | (0.5 kg load) | YI | ΔYI | (GPa) |
| Example 1 | Synthesis | 80 | 2.01 | 4H | 3H | 3.0 | 0.6 | 5.3 |
| | Example 3 | | | | | | | |
| Example 2 | Synthesis | 50 | 1.91 | 4H | H | 2.6 | 0.7 | 6.9 |
| | Example 3 | | | | | | | |
| Example 3 | Synthesis | 80 | 1.95 | 4H | H | 3.0 | 0.6 | 5.4 |
| | Example 4 | | | | | | | |
| Example 4 | Synthesis | 50 | 1.85 | 3H | H | 2.2 | 0.5 | 6.0 |
| | Example 4 | | | | | | | |
| Comparative | Synthesis | 50 | 1.78 | H | HB | 2.4 | 0.4 | 5.6 |
| Example 1 | Example 5 | | | | | | | |
| Comparative | Synthesis | 50 | 1.87 | 3H | H | 3.9 | 0.1 | 5.8 |
| Example 2 | Example 6 | | | | | | | |
| Comparative | PET | 50 | 1.79 | 3B | 5B | 2.2 | 0.0 | 5.1 |
| Example 3 | | | | | | | | |
| Comparative | PC | 50 | 1.67 | B | 3B | 0.6 | 5.7 | 3.3 |
| Example 4 | | | | | | | | |

As can be seen from Table 1, the films having a compressive modulus of greater than or equal to 1.8 GPa and YI of less than or equal to 3 (according to Examples 1 to 4) show no large compressive modulus difference from a film having a thickness of 80 μm and a film having a thickness of 50 μm, greater than or equal to 3H of pencil hardness on a glass substrate, and greater than or equal to H of pencil hardness on a pressure sensitive adhesive agent, PSA. In addition, these films have a tensile modulus of greater than or equal to 5.3 GPa and less than or equal to 0.7 of a satisfactory yellowness index change after UV irradiation for 72 hours.

Accordingly, the film having a compressive modulus of greater than or equal to 1.8 GPa and YI of less than or equal to 3 according to the embodiment satisfies mechanical properties and optical properties required for a window film for a display device.

On the other hand, the films having a compressive modulus of less than 1.8 GPa according to Comparative Examples 1, 3, and 4 have a tensile modulus of greater than or equal to 5 GPa, but less than or equal to 3H of pencil hardness on a glass substrate and less than or equal to HB of very low pencil hardness on a pressure sensitive adhesive agent PSA, and thus, do not satisfy properties required of a window film for a display device.

In addition, the film having a compressive modulus of greater than or equal to 1.8 GPa according to Comparative Example 2 has YI of greater than 3, and thus, is not appropriate for a window for a display device film. The film according to Comparative Example 2 has a high tensile modulus of greater than or equal to 5.3 GPa and greater than or equal to predetermined pencil hardness on a glass substrate and a pressure sensitive adhesive agent, but does not satisfy optical properties as a window film.

While this disclosure has been described in connection with what is presently considered to be practical exemplary embodiments, it is to be understood that the disclosure is not limited to the present embodiments, but, on the contrary, is intended to cover various modifications and equivalent arrangements included within the spirit and scope of the appended claims.

What is claimed is:

1. A poly(amide-imide) copolymer film having a compressive modulus of greater than or equal to about 1.8 gigaPascals and a yellowness index of less than or equal to about 3, when measured according to an ASTM E313 standard.

2. The poly(amide-imide) copolymer film of claim 1, wherein the poly(amide-imide) copolymer film has a thickness of about 25 micrometers to about 100 micrometers.

3. The poly(amide-imide) copolymer film of claim 1, wherein the poly(amide-imide) copolymer film has a tensile modulus of greater than or equal to about 5.3 gigaPascals, when measured according to an ASTM D882 standard.

4. The poly(amide-imide) copolymer film of claim 1, wherein the poly(amide-imide) copolymer film has a pencil hardness of greater than or equal to about 3H on a glass substrate with a vertical load of 0.5 kilograms, when measured according to an ASTM D3363 standard.

5. The poly(amide-imide) copolymer film of claim 1, wherein the poly(amide-imide) copolymer film has a yellowness index change value of less than or equal to about 0.7 after ultraviolet irradiation for 72 hours.

6. The poly(amide-imide) copolymer film of claim 1, wherein the poly(amide-imide) copolymer film comprises a structural unit represented by Chemical Formula 1 and a structural unit represented by Chemical Formula 2: 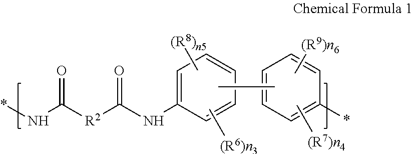
wherein, in Chemical Formula 1,
R² is a substituted or unsubstituted phenylene group,
R⁶ and R⁷ are the same or different and are each independently an electron withdrawing group,
R⁸ and R⁹ are the same or different and are each independently a halogen, a hydroxy group, an alkoxy group (—OR²⁰⁴, wherein R²⁰⁴ is a C1 to C10 aliphatic organic group), a silyl group (—SiR²⁰⁵R²⁰⁶R²⁰⁷, wherein R²⁹⁶, R²⁰⁶ and R²⁰⁷ are the same or different and are each independently hydrogen or a C1 to C10 aliphatic organic group), a substituted or unsubstituted C1 to C10 aliphatic organic group, or a C6 to C20 aromatic organic group,
n3 is an integer ranging from 1 to 4, n5 is an integer ranging from 0 to 3, provided that n3+n5 is an integer of 4 or less,
n4 is an integer ranging from 1 to 4, n6 is an integer ranging from 0 to 3, provided that n4+n6 is an integer of 4 or less; 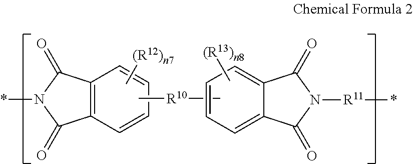
wherein, in Chemical Formula 2,
R¹⁰ is a single bond, a substituted or unsubstituted C1 to C30 aliphatic organic group, a substituted or unsubstituted C3 to C30 alicyclic organic group, a substituted or unsubstituted C6 to C30 aromatic organic group, or a substituted or unsubstituted C2 to C30 heterocyclic group,
R¹¹ comprises a substituted or unsubstituted C4 to C20 aliphatic cyclic group or a substituted or unsubstituted C6 to C30 aromatic organic group, wherein the aromatic organic group is present as a single ring; a condensed ring system comprising two or more fused rings; or two or more aromatic rings linked by a single bond, a fluorenylene group, a substituted or unsubstituted C1 to C10 cycloalkylene group, a substituted or unsubstituted C6 to C15 arylene group, —O—, —S—, —C(═O)—, —CH(OH)—, —S(═O)₂—, —Si(CH₃)₂—, —(CH₂)ₚ— (wherein, 1≦p≦10), —(CF₂)_{q}— (wherein, 1≦q≦10), —C(CH₃)₂—, —C(CF₃)₂—, —C(═O)NH—, or a combination thereof,
R¹² and R¹³ are the same or different and are each independently a halogen, a hydroxy group, an alkoxy group (—OR²⁰⁸, wherein R²⁰⁸ is a C1 to C10 aliphatic organic group), a silyl group (—SiR²⁰⁹R²¹⁰R²¹¹, wherein R²⁰⁹, R²¹⁰ and R²¹¹ are the same or different and are each independently hydrogen or a C1 to C10 aliphatic organic group), a substituted or unsubstituted C1 to C10 aliphatic organic group, or a C6 to C20 aromatic organic group, and
n7 and n8 are each independently an integer ranging from 0 to 3.

7. The poly(amide-imide) copolymer film of claim 6, wherein R¹¹ is represented by Chemical Formula 3: 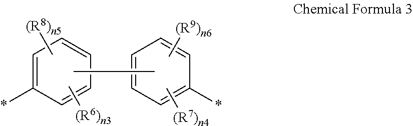
wherein, in Chemical Formula 3,
R⁶ to R⁹, n3, and n4 are the same as defined in Chemical Formula 1.

8. The poly(amide-imide) copolymer film of claim 6, wherein the R⁶ and R⁷ are each independently an electron withdrawing group selected from —CF₃, —CCl₃, —CBr₃, —Cl₃, —NO₂, —CN, —COCH₃, and —CO₂C₂H₅.

9. The poly(amide-imide) copolymer film of claim 6, wherein the structural unit represented by Chemical Formula 1 comprises greater than or equal to 50 mole percent of the structural unit represented by Chemical Formula 1 based on a total number of moles of the structural unit represented by Chemical Formula 1 and the structural unit represented by Chemical Formula 2.

10. The poly(amide-imide) copolymer film of claim 6, wherein the structural unit represented by Chemical Formula 2 comprises a structural unit represented by Chemical Formula 4 and a structural unit represented by Chemical Formula 5: 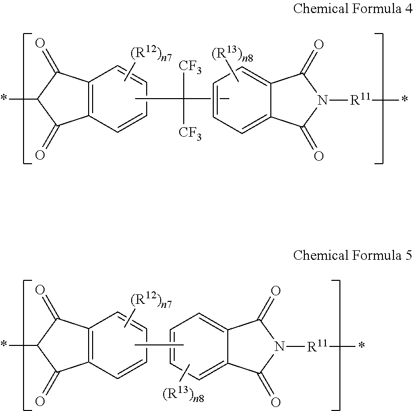
wherein, in Chemical Formulae 4 and 5,
R¹², R¹³, n7, and n8 are the same as defined in Chemical Formula 2.

11. The poly(amide-imide) copolymer film of claim 10, wherein a mole ratio of the structural unit represented by Chemical Formula 4 and the structural unit represented by Chemical Formula 5 is about 1:99 to about 99:1.

12. The poly(amide-imide) copolymer film of claim 6, wherein the structural unit represented by Chemical Formula 1 is represented by at least one of Chemical Formula 6, Chemical Formula 7, and a combination thereof:

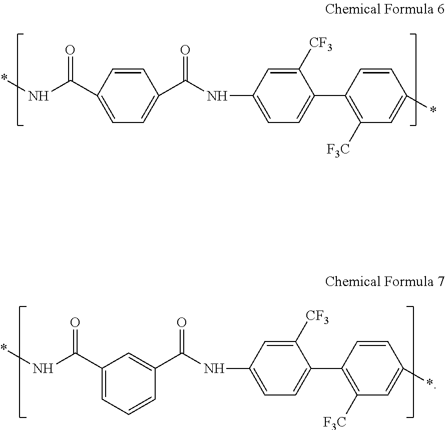

13. The poly(amide-imide) copolymer film of claim 6, wherein the structural unit represented by Chemical Formula 2 comprises a combination of a structural unit represented by Chemical Formula 8 and a structural unit represented by Chemical Formula 9:

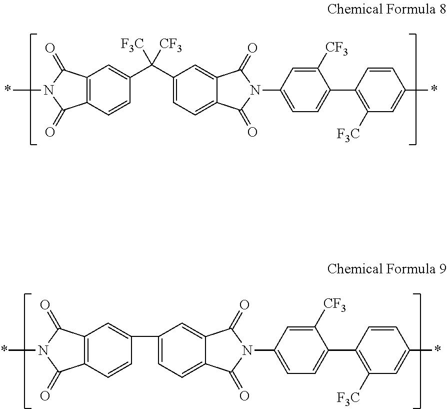

14. The poly(amide-imide) copolymer film of claim 6, wherein the structural unit represented by Chemical Formula 1 is represented by Chemical Formula 6, and the structural unit represented by Chemical Formula 2 is represented by a combination of a structural unit represented by Chemical Formula 8 and a structural unit represented by Chemical Formula 9:

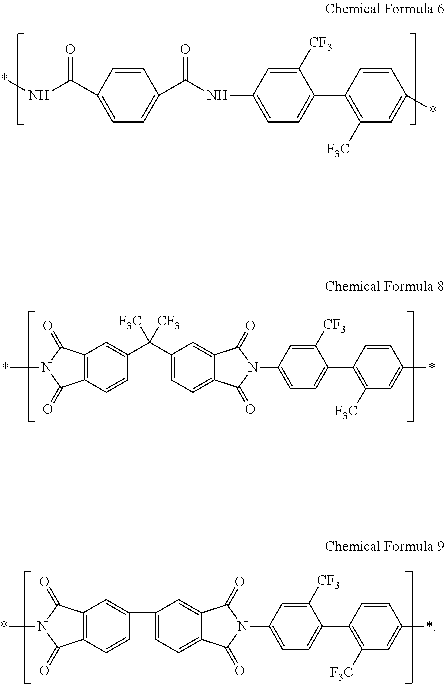

15. The poly(amide-imide) copolymer film of claim 1, wherein a hard coating layer is disposed on at least one side of the poly(amide-imide) copolymer film.

16. The poly(amide-imide) copolymer film of claim 15, wherein the hard coating layer comprises at least one of an acrylate polymer, a polycaprolactone, a urethane-acrylate copolymer, a polyrotaxane, an epoxy polymer, an organosilicone material, an inorganic hard coating material, and a combination thereof.

17. The poly(amide-imide) copolymer film of claim 1, wherein a pressure sensitive adhesive layer is disposed on at least one side of the poly(amide-imide) film.

18. A display device comprising the poly(amide-imide) copolymer film of claim 1.

19. The display device of claim 18, wherein the poly(amide-imide) copolymer film is a window of the display device.

20. The display device of claim 18, wherein the display device is a flexible display device.
